(19) United States
(12) Patent Application Publication
(10) Pub. No.: US 2007/0023328 A1
(43) Pub. Date: Feb. 1, 2007

(54) Recycling horizontal cyclonic segregator for processing harvested nuts and fruits

(76) Inventors: Jonathan J. Flora, Modesto, CA (US); Douglas W. Flora, Modesto, CA (US); Adam L. Benedict, Salida, CA (US)

Correspondence Address: STRATTON BALLEW, 213 S 12TH AVE, YAKIMA, WA, 98902, US

(21) Appl. No.: 11/194,136

(22) Filed: Jul. 29, 2005

(51) Int. Cl. B07B 7/04

(52) U.S. Cl. 209/143

(57) ABSTRACT

A particulate emission reducing cyclonic separator apparatus for removing debris from a raw product stream, including a separation chamber with a scroll. The separation chamber has a supply air port proximate to a lower scroll portion, a raw product feed port proximate to a mid scroll portion, a top debris outlet port proximate to an upper scroll portion, and a bottom product outlet port proximate to the lower scroll portion. A supply air stream feeds into the separation chamber through the supply air port, establishing cyclonic flow within the scroll. The cyclonic flow has an approximately horizontal axis of cyclonic flow. A raw product, including a debris and a product, feeds into the separation chamber through the raw product feed port. A debris stream, produced by separation of the raw product stream within the separator chamber, exits the separation chamber through the top debris outlet port. A product stream, also produced by the separation of the raw product stream within the separator chamber, the product stream exits the separation chamber through the bottom product outlet. A settling chamber receives the debris, and to recycle the airstream, fan return air is drawn from the settling chamber. The product is preferably almonds, but can be any fruit or nut gathered from a field orchard or grove.

### TECHNICAL FIELD

The invention relates to an apparatus for processing bulk harvested nuts and fruits, and more specifically, to a recycling cyclonic segregator, preferably incorporated within a mobile apparatus that picks-up fruits and nuts from the ground and conditions them, in bulk. The segregator apparatus conditions the fruits and nuts by removing debris with a horizontally oriented cyclone, powered by a high volume blower.

### BACKGROUND OF THE INVENTION

Currently, best management practices for farms, orchards and groves require the use of technologies that minimize the generation of dusts and debris. Dust control measures are required in many current regulatory efforts, implemented to reduce dust impacts to workers on-site, and to residents and citizens offsite. Soil conservation is also a benefit of reductions in dust generation, typically associated with harvesting operations in drier climates.

Specifically, in the harvesting of nuts and fruits, these fruits and nuts are first shaken or otherwise removed from the trees, bushes or vines, as required. The modem retrieval of these nuts and fruits from the ground conventionally requires the use of a conveyor pick-up system. To minimize the generation of dust from these pick-up operations, the conveyors are maintained under negative air pressure.

These prior harvesting apparatus perform well to clean dust and debris from the fruits and nuts collected. However these devices generate significant amounts of dust or “PM” defined as particulate material. Specifically, particulate material of greatest concern to human health are “PM10,” which are typically defined as respirable particulate material or dusts with an average aerosol diameter” of less than 10 microns, and PM2.5, which are dusts with an average aerosol diameter of less than 2.5 microns. With significant pressures from regulatory governmental agencies to drastically reduce dust generated by harvesting operations and further to conserve top soils, a great need exists for harvesters with lower dust emission rates.

Dust separation systems often employ air circulating centrifugal separators or “cyclones” to remove dusts from airstreams. U.S. Pat. No. 4,885,817 shows a negative air pressure cyclone for removing and collecting dust from an airstream. However, negative air pressure or vacuum systems typically require large, powerful fans. Additionally, the broad range of dusts and debris gathered in typical harvesting operations require systems that efficiently remove debris over a wide range of sizes and weights. Therefore, a mobile harvesting system for fruits and nuts is needed that better conditions or processes the raw, gathered fruit or nut product with recirculated air, to efficiently remove debris from the raw product.

### BRIEF DESCRIPTION OF DRAWINGS

FIG. 1 is a partially sectioned perspective view of a conditioner apparatus including a cyclonic segregation system, according to an embodiment of the invention;

FIG. 2 is a perspective view of a conditioner apparatus including a cyclonic segregation system, according to an embodiment of the invention;

FIG. 3 is a partially sectioned perspective view of a conditioner apparatus including a cyclonic segregation system, according to an embodiment of the invention;

FIG. 4 is a partially sectioned side view of a conditioner apparatus including a cyclonic segregation system, according to an embodiment of the invention;

FIG. 5 is a partially sectioned top view of a conditioner apparatus including a cyclonic segregation system, according to an embodiment of the invention;

FIG. 6 is a partially sectioned perspective view of an air and product flow schematic detail of a cyclonic segregation system, according to an embodiment of the invention;

FIG. 7 is a side view of a conditioner apparatus with tractor and towable bin including a cyclonic segregation system, according to an embodiment of the invention; and

FIG. 8 is a side view of a conditioner apparatus with tractor including a cyclonic segregation system, according to an embodiment of the invention.

### DETAILED DESCRIPTION OF SPECIFIC EMBODIMENTS

The present invention provides a cyclonic segregation system, specifically useful with a tree nut harvester, or within a conditioner of nuts or fruits. For the purposes of the present detailed description, the term “conditioner” may be used to describe any apparatus that processes fruits or nuts, in bulk. Typically, conditioners are used for the retrieval of the fruits or nuts from the field, grove or orchard, or for the formation of the fruits or nuts into windrows on the ground surface, for further drying in the field.

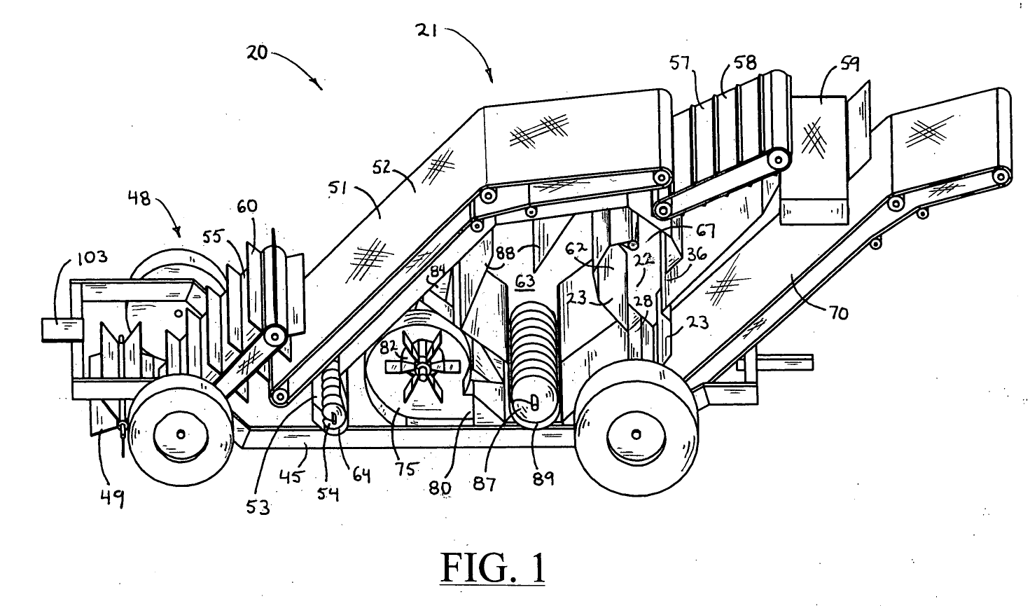

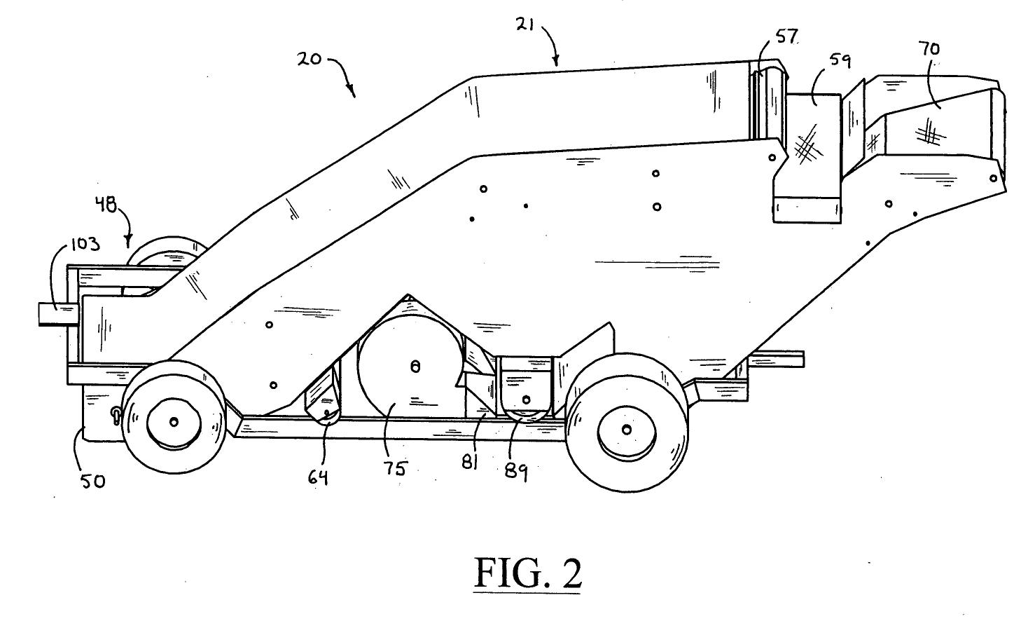

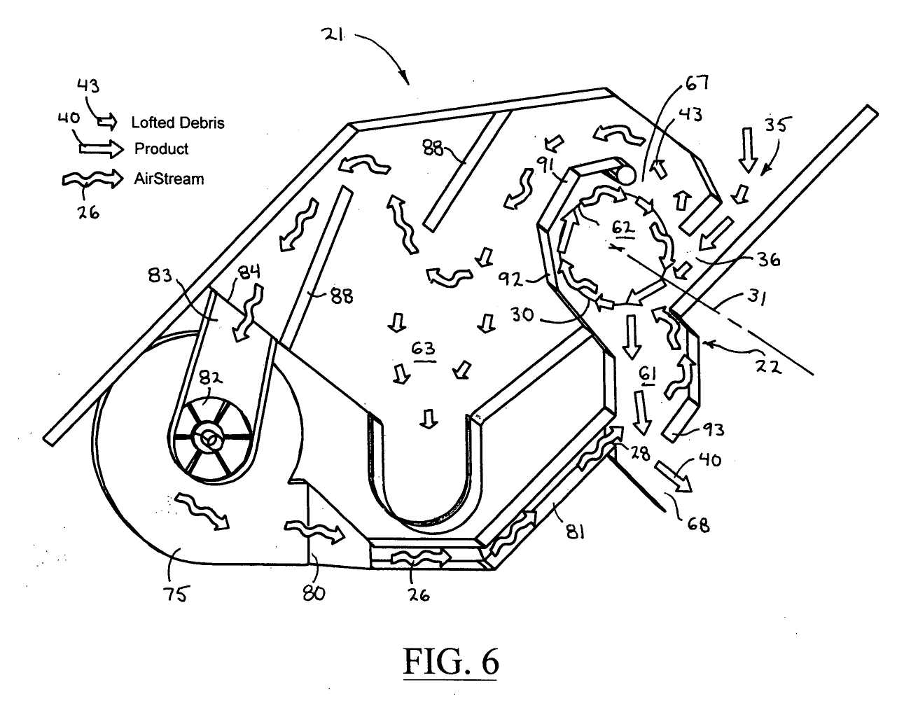

As shown in FIGS. 1 through 8, a conditioner 20, employing the cyclonic segregation system 21 of the present invention, includes a separation chamber 22 having a scroll 23, which is preferably positioned horizontally, relative to a ground surface 25. As detailed in FIG. 6, the separation chamber receives a supply air stream 26 along the horizontal length of the scroll, at a supply air port 28. The supply air stream establishes a cyclonic flow 30 within the scroll.

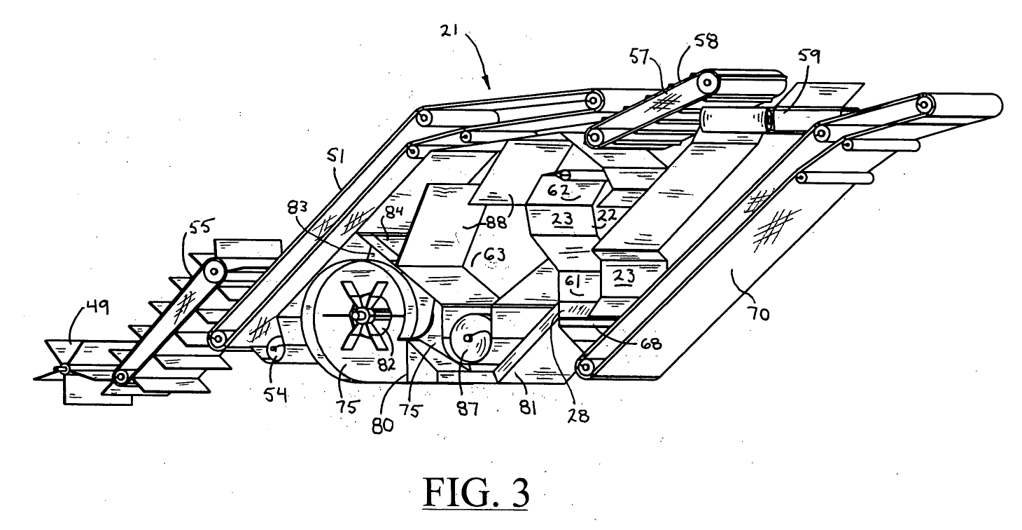

To direct the supply airstream 26 in the circular, cyclonic flow 30, the scroll 23 is most preferably in the general form of a cylinder, as shown in FIG. 3, sized to provide the required rotational speed of the cyclonic flow and achieve the desired separation effects, as discussed further herein. The supply air port 28 feeding the separation chamber 22 is most preferably in the conventional form of a slot type of diffuser. The term “slot,” when used in this disclosure, referrers to an opening or port, sized with a “high aspect ratio,” defined as having a long width relative to a short height of the opening. Specifically, the long and narrow, high aspect ratio slot of the supply air port, imparts a high velocity to the supply air stream along the supply air port, preferably spanning the entire horizontal length of the separation chamber.

The cyclonic flow 30 has an axis of cyclonic flow 31, as shown in FIG. 6. The axis of cyclonic flow is the center of flow's rotation. For the present invention, the axis of cyclonic flow is approximately horizontal. In nature, a tropical storm hurricane, or a wind generated tornado are two examples of approximately vertical axis of cyclonic flow. However, the curling of a breaking ocean wave is an example found in nature of an approximately horizontal axis of cyclonic flow. Additionally, the term “approximately” is used herein to refer to a range of values or relative orientations, understood by a person skilled in the pertinent field or skill, as being substantially equivalent to the herein stated values in achieving the desired results, a range typical to the accuracy and precision of conventional tooling or techniques, or a functionally equivalent range of features that produces equivalent results to those described herein. For instance, the term “approximately horizontal” is employed in the present description and claims to refer an orientation of the axis of cyclonic flow, as being remarkably and distinctly unique, or in a separate descriptive classification, as compared to the vertical axis of cyclonic flow. Vertical cyclones, with vertical axises of cyclonic flow, are universally employed in conventional material separation systems, especially those separating solids in a pneumatic or air fluidizing system, as described herein.

A “raw” or unprocessed material stream, referred to herein as a raw product stream 35, is introduced into the separation chamber 22, along the length of the scroll 23, at a raw product feed port 36, as shown in FIG. 6. The raw product stream includes debris 39 and a product 40. The debris includes a fallout debris 41, a stick debris 42, and a lofted debris 43. The product includes the desired fruit or nut to be harvested. In this preferred embodiment of the cyclonic segregation system 21, the product is preferably almonds 44.

The conditioner 20 with the cyclonic segregation system 21 of the present invention, is well suited for the processing of almonds 22, but could be utilized in the processing of any one of a variety of harvested crops, the harvested crop lying on or deposited on the ground surface 25, after removal from a tree, bush or planting. As an alternative to the almonds, the harvested crop may be another variety of nut, such as cashews, chestnuts, hazelnuts, macadamia nuts, pecans, walnuts and tung nuts. Certain fruits, such as figs and oranges, and additionally any fruit, nut or vegetable, as conventionally known to require collection and processing from the ground, can be served with the present invention.

The removal of the almonds 22 from the tree is conventionally achieved by a shaker. The design and operation of the shaker is well known in the field of nut harvesting. The almonds, in an unprocessed condition and covering the ground surface 25. Along with the almonds, debris 39 is typically scattered on the ground surface. The debris is typically a collection of dirt, leaves, twigs and trash, as normally found littering the ground surface of any orchard, farm or grove. The almonds and debris, initially scattered on the ground surface, are a raw product 46, which is processed by the conditioner 20 as the raw product stream 35.

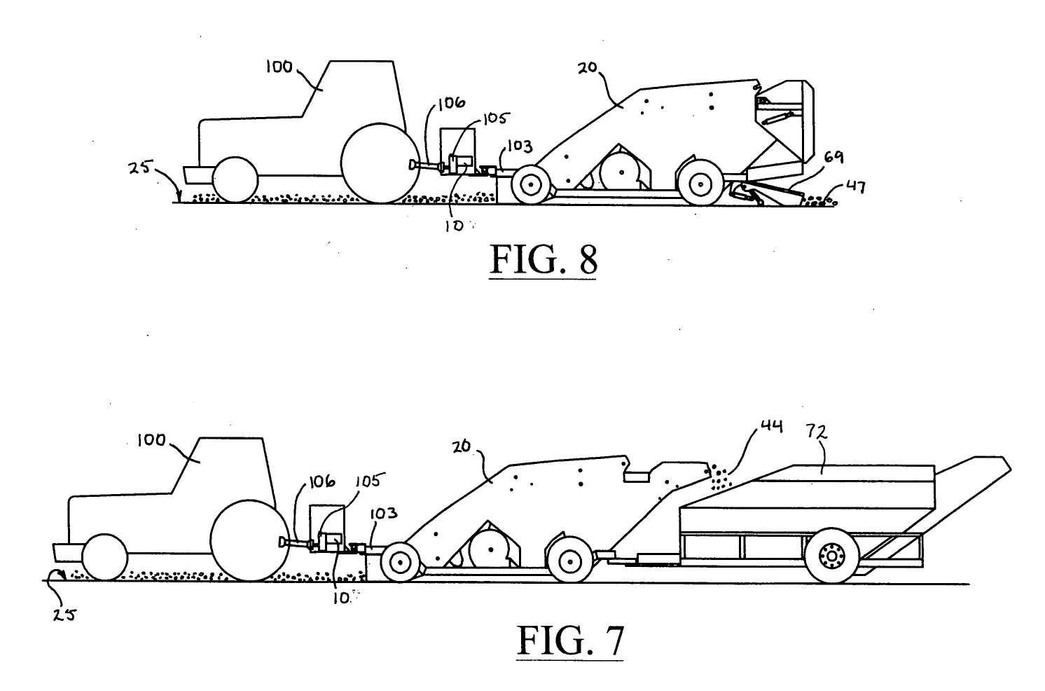

When, as preferred, the product 40 is tree nuts, such as almonds 44, conventional harvesting operations typically result in the production of a windrow 47 of the almonds, mounded on the ground surface 25, as shown in FIGS. 7 and 8, for further drying after removal from the tree. After the windrow of almonds is properly dried and ready for retrieval, the conditioner 20 is employed to collect the windrow. The present invention may be employed in either a conditioner or a harvester of tree nuts. The term “conditioner” used in the present specification, refers generally to the process of conditioning the product for collection, harvest, transfer, or any other processing activity. The conditioning process may certainly be included in a harvester, as well as within a conditioner. The term “conditioner” as used herein, does not limit the use of the cyclonic segregation system of the present invention to a specific conditioner apparatus, but any conditioning, harvesting or general processing apparatus employing the present invention for raw product segregation purposes.

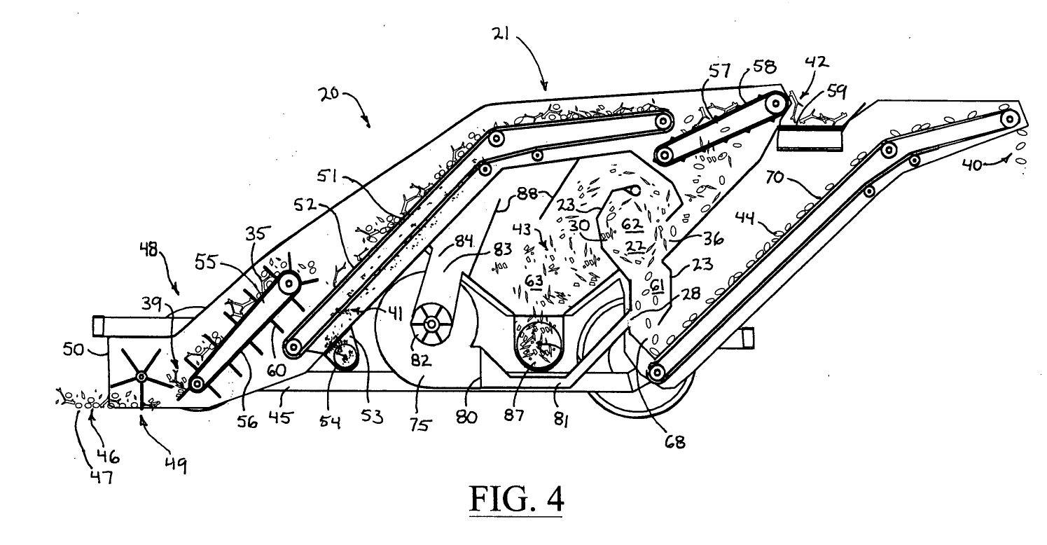

To collect the raw product 47 into the conditioner 20 for processing with the present invention, the conditioner employs an uptake section 48, as shown in FIG. 4. The uptake section preferably includes a sweeper array 49, within an infeed scoop 50. The sweeper array is positioned to contact the ground surface, immediately ahead of the infeed scoop. A preferred, “paddle wheel” type of sweeper array is shown in FIGS. 1 and 4. The conditioner equipped with the cyclonic segregation system 21 is preferably modular in design, with any number or variety of conventional components, in addition to the cyclonic segregation system of the present invention, mounted on a frame 45.

To increase the effectiveness of the cyclonic segregation system 21, prior to introduction into the separation chamber 22, the raw product stream 35 is preferably pre-processed within the conditioner 20, by an initial removal of the fallout debris 41 and the stick debris 42.

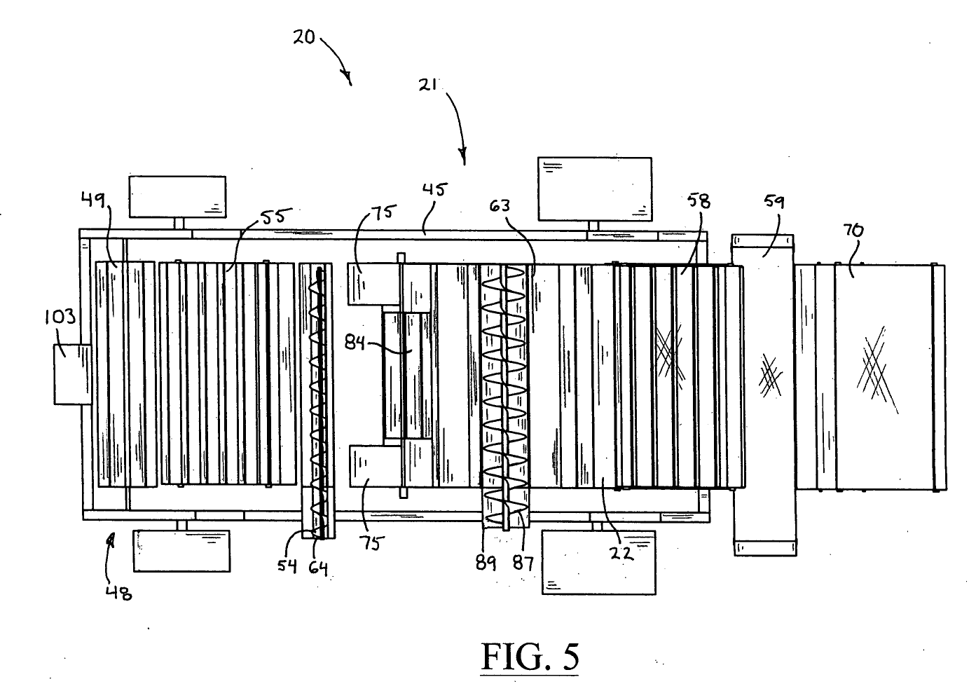

The raw product stream initially includes various particulate material, such as gravel and granules of dusts and dirt. This particulate fraction of the debris 39 is termed herein as the fallout debris 41. The removal of this fine particulate, fallout debris is most preferably accomplished with a cleaning conveyor 51, which is a conventional conveyor equipped with a meshed belt 52, as shown in FIG. 1. The meshed belt is preferably an open, metal sieve, sized to retain the almonds 44 on the meshed belt. The meshed belt is preferably sized to allow the debris 39 smaller than the product to fall through the belt. To minimize dust generation, the fallout debris that passes through the meshed belt of the cleaning conveyor is most preferably gathered into a fallout chute 53, preferably equipped with a fallout auger 54 that includes a fallout port 64. The fallout auger pushes the fallout debris out of the fallout port, to the outside of the conditioner 20, and onto the ground surface 25 outside the path of the conditioner, as shown in FIG. 5.

Additionally, the uptake section 48 preferably includes an uptake conveyor 55, which transfers the raw product stream from the sweeper array and ground surface 25 to the cleaning conveyor. The uptake conveyor preferably includes an uptake belt 56, which is equipped with uptake flights 60, as shown in FIG. 1. The uptake flights, are most preferably parallel slats of metal, in combination with rubber. The uptake flights serve to prevent the product 40 from falling, back toward the infeed scoop 50 and the ground surface. Uptake flights may also be included in the cleaning conveyor 51, and the elevator conveyor 70, if desired.

After removal of the fallout debris 41, the raw product stream 35 preferably routes to a stick removal conveyor 57, for removal of the stick debris 42 from the raw product stream. The stick debris includes twigs, sticks and small branches typically gathered by the conditioner, in the process of retrieving the raw product stream from the ground surface 25. Pre-removal of the stick debris prior to introduction into the separation chamber 22 also increases the effectiveness of the cyclonic segregation system 21 of the present invention, preventing the formation of “mats” or “clogs” of stick debris within the separation chamber. The stick removal conveyor is also a conveyor of conventional design, with gaps in a slotted belt 58. The gaps allow the product 40 to pass through the slotted belt, while retaining the stick debris 42 on the belt. The stick debris retained upon the slotted belt is preferably fed onto a stick cross belt 59, as shown in FIG. 1. The stick cross belt is a conventional endless belt conveyor that transfers the sticks debris to the outside of the conditioner 20, and deposits the stick debris upon the ground surface.

Upon removal of the fallout debris 41 and the stick debris 42 from the raw product stream 35, only the product 40 and the lofted debris 43 substantially remain in the raw product stream 35. The cyclonic chamber 62 of the present invention is well described as a material “segregator,” not just a separator. The lofted debris is lifted up and discharged out of the cyclonic chamber 62, by the cyclonic flow 30 of the supply air stream 26, while the product falls into and through the product fallout chamber 61. This segregation is achieved due to certain differences in physical properties of the lofted debris as compared to the product. Specifically, the lofted debris is typically less aerodynamic and less dense than the product.

The term “aerodynamic” is employed in this detailed description, to denote an object's ability to move through an airstream. In comparing the aerodynamics of two objects, a force of a passing airstream applies less velocity pressure or force upon the more aerodynamic of the two objects. An object's weight also plays a role in determining whether that object will be lifted or “lofted” by an airstream. A light object requires less force to lift or loft, as compared to a heavier object with equivalent aerodynamic properties.

For the present invention, the product 40 is typically a fruit or nut with a substantially spherical shape. The most preferred product, almonds 44, still encased in their soft protective hulls have an elongated or ovoid shape, somewhat resembling a standard rugby ball. The almond is significantly more aerodynamic than the typical, irregularly shaped debris 39 picked-up by the conditioner 20. This is especially the situation observed in the raw product stream 35 after the cleaning conveyer 51 and the stick removal conveyer 55, take away substantially all debris from the raw product stream, leaving the lofted debris 43 and the product.

The lofted debris 43 that remains in the raw product stream 35, on entry into the separation chamber 22, is typically leaves and lighter trash, all of which are too large to fit through the mesh belt 52 of the cleaning conveyor 51, and too lengthy to fit through the slotted belt 58 of the stick removal conveyor 57. The lofted debris tends to have a lower weight, as compared to the product 40. With its lighter weight and less aerodynamic properties, the lofted debris 43 is easily lifted, up and out of a top trash outlet 67 of the cyclonic chamber 62, and into a settling chamber 63.

Conversely, the product 40, with its typically heavier weight and more aerodynamic properties, as compared to the lofted debris 43, falls through the cyclonic chamber 62 and into the product fallout chamber 61. From the product fallout chamber, the product continues to fall and exits the product fallout chamber through a bottom product outlet port 68. The bottom product outlet port is preferably a slot, as shown in FIGS. 3 and 6. Most preferably, an elevator conveyor 70 receives the product from the bottom product outlet port and transports the product upward to a bin 72, or receptacle, for storage or further transport. As shown in FIG. 7, the bin is preferably towed behind the conditioner 20. However, as an alternative, the conditioner can include the bin, for transport of the product.

Also alternatively, the product 40 exiting the bottom product outlet port 68 and substantially free of debris 39, may be deposited back to the ground surface 25, for later retrieval. For this alternative, a nut hopper 69 collects and funnels the product into a processed windrow 47, returning the product, most preferably almonds 44, to the ground surface behind the conditioner 20.

For generating the supply airstream 26 within the separation chamber 22, a blower 75 is employed. Preferably, the blower is a standard, industrial quality, high volume fan. The blower is preferably selected to generate sufficient air flow to form the cyclonic flow 30 within the separation chamber. The optimum blower size and required horsepower is readily selectable by a person skilled in fan and fan motor selection. Preferably, for the cyclonic segregation system of the present invention, two blowers are employed in a parallel configuration, as shown in FIG. 5. A preferred blower is a model “LS 194,” as manufactured by New York Blower Co. of Willowbrook, Ill., USA, An alternative blower is a model “RBO 911,” as manufactured by Twin City Fan & Blower Co., of Minneapolis, Minn., USA. Either preferred blower is a centrifugal fan including a nominal, 19 inch diameter industrial, radial (paddle wheel) style off an blade, and generates approximately 5,000 CFM at 2400 RPM, and requires approximately 14 BHP, to operate at approximately 3 to 4 inches w.g. of static. However, other fan blade and fan types, as well known to those skilled in fan selection, are considered for use with the present invention.

The blower 75 is preferably positioned as shown in FIG. 1, and includes a “supply side,” referred to herein as a blower supply 80, and a “suction side,” referred to herein as a blower return 82. As shown in FIGS. 4 and 6, a supply air duct 81 connects the blower supply to the supply air port 28 in the product fallout chamber 61. A return air duct 83 connects the settling chamber 63, at a return air port 84, to the blower return. Most preferably, the return air duct pulls a return air stream 66 from the settling chamber, which provides for a recycling of the supply air stream 26, and greatly reduces particulate emissions from the cyclonic segregation system 21. This recycling of the airstream also provides for an operational economy, by reducing the requisite blower size and power, and by substantially eliminating the discharge of air to the outside the cyclonic segregation system, eliminates the air filtration otherwise necessary to remove the lofted debris 43, processed by the separation chamber 22.

As noted above, the settling chamber 63 includes the top trash outlet 67 connection to the cyclonic chamber 62. The settling chamber also includes the return air port 84 connection to the return air duct 83 of each blower 75. Instead of discharging the supply air stream 26 out of the settling chamber to the atmosphere, as typical of prior devices, the supply air stream is re-used by the blower 75. Again, in a preferred embodiment of the cyclonic segregation system 21, two blowers and two return air pots are utilized, each routed from the return air duct, as shown in FIG. 5. By preventing the constant exhaust of high velocity air and dust, as especially associated with nut harvesting, potential “PM10.” “PM2.5,” or otherwise defined respirable particulate contributions to the atmosphere, are greatly reduced.

Additionally, the settling chamber 63 preferably includes a debris chute 86, equipped with a debris auger 87, which includes a debris port 89. The debris auger pushes the lofted debris 43 gathered within the settling chamber out of the debris port, to the outside of the conditioner 20, and onto the ground surface 25, outside the path of the conditioner.

In a preferred alternative to the debris auger 87, a rotary mulching blade may be added to the debris port 89. The conventional mulching blade preferably operate at a high rpm, to chop the lofted debris 43 into a mulch. Also alternatively, a rotary valve may be mounted to the debris port to limit the flow of air back into the settling chamber 63. The rotary valve is a standard mechanism, typically utilized for the controlled and substantially airtight withdrawal of fine materials from hoppers or similar containers.

The settling chamber 63 is most preferably configured as shown in FIG. 1, with a baffle 88, to route the lofted debris downward and away from the return air port 84, but alternatively could include filters, additional baffles, or any such internal mechanisms for entraining, knocking out, or settling out the lofted debris carried by the supply air stream 26 into the settling chamber from the cyclonic chamber 62.

Segregation of the raw product stream 35 into component fractions of the product 40 and the lofted debris 43, chiefly occurs within the cyclonic chamber 62 of the separation chamber 22. Again, the cyclonic flow 30 of the supply air stream 26 drives the lighter and irregularly shaped lofted debris 43 up and out of the scroll 23 of the cyclonic chamber through the top trash outlet port 67. The top trash outlet port is preferably a slot in form, positioned proximate to an upper scroll portion 91, and traversing the upper scroll portion approximately horizontally and lengthwise, as shown in FIG. 6. The raw product feed port 36 is preferably positioned proximate to a mid scroll portion 92, located below the top trash outlet port. Similar to the top trash outlet port, the raw product feed port is also preferably a slot in form, traversing the mid scroll portion approximately horizontally and lengthwise, as also shown in FIG. 6. The cyclonic chamber is formed from the upper scroll portion and the mid scroll portion of the scroll. The form of the scroll, as shown in FIG. 6, facilitates the formation of the cyclonic flow within the cyclonic chamber, as the supply air stream enters the cyclonic chamber from the product fallout chamber, directly below.

As discussed above, the supply air stream 26 enters the separation chamber 22 through the supply air port 28. The supply air port is preferably located in the product fallout chamber 61 of the separation chamber, proximate to a lower scroll portion 93 of the scroll 23. The flow of the supply air stream from the supply air port, is preferably deflected by the scroll, to facilitate the formation of the cyclonic flow 30, as shown in FIG. 6.

When processed within the separation chamber 22, the product 40, which is relatively heavier and more aerodynamic than the lofted debris 43, drops out of the cyclonic chamber into the product fallout chamber 61, against the flow of the supply air stream 26. The bottom product outlet port is preferably also the form of a slot, along the horizontal length of the product fallout chamber, as shown in FIG. 6.

The conditioner 20 equipped and configured as discussed in relation to the present invention, is preferably towed from a tractor 100, as shown in FIGS. 7 and 8. The conditioner can be configured as a towed trailer, with a hitch 103. The hitch mounts to the conditioner and attaches to the tractor. Power to operate the various moving parts of the conditioner is preferably accomplished by hydraulics. For the towed configuration, the tractor preferably provides the power for a central hydraulic system 104. The general configuration and operation of these hydraulic motors and controls are of a conventional design. These conventional controls are known to those skilled in hydraulic actuation and controls. The preferred hydraulic system of control for use with the present invention, is powered by a central hydraulic pump 105, which in turn is powered by the engine of the conditioner 20. The central hydraulic pump is run by a “power-take-off” 106, or PTO, as is well known in persons skilled in farming and orchard equipment. The engine of the tractor includes a transmission linkage to a PTO. Alternatively, the conditioner can be self contained and self powered, which also includes the central hydraulic system powered by the hydraulic pump. The central hydraulic pump can be placed on the frame 45, and supply high pressure hydraulic fluid for actuating all powered elements of the conditioner, including drives, steering, motors, conveyers and fans.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. (canceled)

2. A cyclonic segregator apparatus for removing a debris from a raw product, the cyclonic segregator apparatus including:
a separation chamber within a scroll, the scroll having a lower scroll portion, a mid scroll portion, and an upper scroll portion, the separation chamber having a supply air port proximate to the lower scroll portion, the separation chamber having a raw product feed port proximate to the mid scroll portion, the separation chamber having a top debris outlet port proximate to the upper scroll portion, and the separation chamber having a bottom product outlet port proximate to the lower scroll portion;
a supply air fed into the separation chamber through the supply air port;
a cyclonic flow established within the separation chamber by the supply air, the cyclonic flow within the separation chamber having an axis of cyclonic flow, the axis of cyclonic flow approximately horizontal in relation to a ground surface, and the scroll of the separation chamber positioned to maintain the axis of cyclonic flow approximately horizontal in relation to a ground surface;
the raw product fed into the separation chamber through the raw product feed port;
the debris initially included in the raw product, the debris separated from the raw product within the separation chamber, and the debris exits the separation chamber through the top debris outlet port; and
a product initially included in the raw product, the product separated from the raw product within the separator chamber, and the product exits the separation chamber through the bottom product outlet port.

3. The cyclonic segregator apparatus of claim 2, additionally including:
a blower for generating the supply air, the blower having an air return;
a settling chamber for receiving the debris from the bottom product outlet port; and
a return air drawn from the settling chamber by the blower into the air return of the blower.

4. The cyclonic segregator apparatus of claim 2, wherein:
the supply air fed into the separation chamber through the supply air port is a supply air stream, and the scroll directs the supply airstream in the cyclonic flow.

5. The cyclonic segregator apparatus of claim 2, wherein:
the raw product fed into the separation chamber through the raw product feed port is a raw product stream.

6. The cyclonic segregator apparatus of claim 5, wherein:
the debris is a debris stream, the product is a product stream, and the raw product stream includes the debris stream and the product stream.

7. The cyclonic segregator apparatus of claim 6, wherein:
the debris stream is lofted from the raw product stream by action of the airstream within the separation chamber to exit the separation chamber through the top debris outlet port; and
the product stream falls from the raw product stream within the separation chamber to fall into the separation chamber through the bottom product outlet.

8. The cyclonic segregator apparatus of claim 7, additionally including:
a blower having an air supply and an air return, the blower for generating the supply air stream ducted from the air supply, with a return air stream drawn into the air return; and
a settling chamber for receiving the debris stream from the bottom product outlet, the return air stream drawn from the settling chamber by the blower.

9. The cyclonic segregator apparatus of claim 6, wherein:
the scroll is cylindrical in form and the scroll directs the supply airstream to combine with the raw product stream in the cyclonic flow, the cyclonic flow having a rotational speed within the separation chamber, and the scroll sized to achieve a separation of the debris stream and the product stream from the raw product stream.

10. The cyclonic segregator apparatus of claim 2, wherein:
the product is a harvested crop selected from the group consisting of fruits, nuts and vegetables.

11. The cyclonic segregator apparatus of claim 2, wherein:
the product is a harvested crop selected from the group consisting of cashews, chestnuts, hazelnuts, macadamia nuts, pecans, walnuts, tung nuts, figs and oranges.

12. The cyclonic segregator apparatus of claim 2, wherein:
the product is an almond.

13. The cyclonic segregator apparatus of claim 2, additionally including:
an uptake for collecting the raw product, the raw product lying on a ground surface in a scattered covering, the scattered covering including the product and the debris.

14. The cyclonic segregator apparatus of claim 2, additionally including:
a pre-processing of the raw product, prior to feeding the raw product into the separation chamber to remove non-aerodynamic debris, from the raw product.

15. A method for cyclonically segregating a debris from a raw product, the cyclonic segregation method including the steps of:
a) directing a supply airstream along the length of a scroll, the scroll enclosing a separation chamber, and the scroll positioned horizontally relative to a ground surface;
b) establishing a cyclonic flow within the separation chamber;
c) feeding a raw product into the separation chamber, the raw product including a debris and a product;
d) cyclonically segregating the raw product into the debris and the product within the separation chamber;
e) lofting the debris within the separation chamber;
f) discharging the debris from the separation chamber through a trash outlet, the trash outlet located proximate to the top of the separation chamber; and
g) discharging the product from the separation chamber through a product fallout chamber, the product fallout chamber located proximate to the bottom of the separation chamber.

16. The cyclonic segregation method of claim 15, including the additional step of:
h) discharging the debris from the separation chamber into a settling chamber; and
i) recycling the airstream directed into the scroll of the separation chamber, from the settling chamber.

17. A cyclonic segregator apparatus for removing a debris from a raw product, the cyclonic segregator apparatus including:
an airstream generated by a blower;
a separation chamber having a scroll, the scroll including a top and a bottom, the airstream ducted from the blower into the scroll to establish a cyclonic flow within the separation chamber, the cyclonic flow within the separation chamber having an axis of cyclonic flow, the axis of cyclonic flow approximately horizontal in relation to a ground surface;
the raw product fed into the separation chamber, the raw product including the debris and a product, the debris lofted by the airstream and discharged from the separation chamber proximate the top of the scroll, and the product falls through the separation chamber and discharged from the separation chamber proximate the bottom the scroll.

18. The cyclonic segregator apparatus of claim 17, additionally including:
a settling chamber for receiving the debris from the scroll; and
a return air drawn from the settling chamber by the blower, for use as a return airstream by the blower.

19. The cyclonic segregator apparatus of claim 17, wherein:
the scroll is cylindrical in form and the scroll directs the airstream to combine with the raw product in the cyclonic flow, the cyclonic flow having a rotational speed within the separation chamber, and the scroll sized to achieve a separation of the debris and the product, from the raw product.

20. The cyclonic segregator apparatus of claim 17, wherein:
the product is a harvested crop selected from the group consisting of fruits, nuts and vegetables.

21. The cyclonic segregator apparatus of claim 2, wherein:
the product is an almond.
